(19) United States
(12) Patent Application Publication
(10) Pub. No.: US 2007/0188477 A1
(43) Pub. Date: Aug. 16, 2007

(54) Sketch pad and optical stylus for a personal computer

(76) Inventor: Peter H. Rehm, Orem, UT (US)

Correspondence Address: Peter H. Rehm, 115 E 900 S, Orem, UT, 84058, US

(21) Appl. No.: 11/353,608

(22) Filed: Feb. 13, 2006

(51) Int. Cl. G06F 3/033

(52) U.S. Cl. 345/179

(57) ABSTRACT

A notebook computer has tablet and stylus functionality and drawing tool selection functionality by providing indicia near the keyboard and by providing an optical stylus that can recognize the indicia. The indicia includes a sketch pad area that cooperates with the optical stylus to transmit X and Y coordinates to the computer. Other indicia represents tool buttons. These tool buttons are recognized by both human users and by the optical stylus, which causes the computer to respond with the appropriate drawing tool or mode. The notebook computer may be manufactured with the indicia in place or the indicia may be provided on adhesive stickers to be added to any notebook computer. In the latter case, the stickers may be selected and positioned as desired by the end user. The sticker are thin enough to permit the notebook computer to be closed as usual. In an alternative embodiment that also uses little or no space, the indicia is printed on a mouse pad or other surface to provide tablet and stylus functionality to other kinds of personal computers as well. Optionally, the optical stylus is provided with driver software that communicates messages directly to an application program without affecting the normal mouse cursor.

### BACKGROUND OF THE INVENTION

For many years, computer users have had the option of purchasing a digitizing tablet and stylus for their computers. A tablet and stylus allows the user to move the computer's cursor with a pen-shaped device called a stylus. When drawing sketches or creating other types of artwork on screen, a stylus can be used more naturally than a mouse or trackball or other type of input device.

Most styluses are sensitive to the “pressure” (i.e., force) with the user applies the stylus to the tablet, and this force data is used by application software to determine characteristics such as line or brush width, darkness, or other quality that is applied to a digital canvas.

Many digitizing tablets use electromagnetic fields to determine the location of the stylus. The tablet is thus an active device that that has rows and columns of wires, or loops of wires, for generating the fields. The stylus includes electronics that interact with these fields.

Such digitizing tablets are provided as a separate devices for use with desktop computers. They are too large and cumbersome for portable use with a notebook computer. Even with a desktop computer, they can consume valuable space.

ANTO COMPONENTS (anoto.com) provides pen-and-paper based solutions for portable sketching. For example, the Logitech Digital Pen can be used to draw handwriting and sketches in real ink on “smart paper.” It is not even necessary to have a computer nearby. The smart paper has absolute position codes encoded all over its surface. These codes are in indicia that is generally invisible to the human eye. However, the Pen “sees” the absolute position codes on the smart paper and stores the handwriting and sketching gestures in the pen for later download to a computer.

### OBJECTS AND SUMMARY

It is an object of this invention to provide a way to add easily portable tablet and stylus functionality to an existing notebook computer, as well as supporting functionality for drawing sketches.

Another object is to provide a way that notebook computers can be manufactured with the tablet portion already built-in, with virtually no redesign of the notebook computer itself.

Another objective is to provide a way for desktop computer users to enjoy a tablet and stylus without the need to find a place to store a large and cumbersome tablet.

These objectives and others unmentioned can be attained as follows.

A personal computer can be upgraded with a sketch pad and stylus by providing an optical stylus and placing coded indicia on an existing surface on or near the computer. The coded indicia includes a sketch pad area and optionally an assortment of tool buttons. The coded indicia can be applied via a thin adhesive sticker, printed directly on the surface of the computer, or printed on another surface. The invention is especially advantageous for notebook computers because the stickers or indicia take up virtually no space, allowing the notebooks to be closed as normal, and yet add all the functionality of a stylus and tablet.

The sketch pad is coded with indicia that can be detected by an optical stylus, permitting the computer to always track the stylus's absolute position when it is near a sticker. The optically stylus transmits the X and Y coordinates that it “sees” on the sketch pad to the computer. The stylus also detects contact with the stickers, and optionally force (“pencel pressure) as well. These transmissions may be wired or wireless.

Various additional indicia-bearing stickers present an assortment of tools such as pens, brushes, erasers, colors, line weights, shapes and smart shapes. These tools can be selected by touching them with the stylus. These tools can be accessed faster and more conveniently by placing them outside the sketch pad than by providing them as soft tools somewhere on the computer display.

### BRIEF DESCRIPTION OF THE DRAWINGS

FIGS. 1A-1B are side views of a two different kinds of wireless styluses.

FIG. 2 is a side view of a wired stylus according to the current invention.

FIG. 3 is a top view of a sketch pad according to the invention.

FIG. 4 is a top view of three sketch pad stickers of varying size.

FIG. 5 is a top view of a variety of tool stickers.

FIG. 6 is a top view of a notebook computer as modified by the current invention.

FIG. 7 is a top view of a base member having a sketch pad and some tools.

FIG. 8 is a top view of a mouse pad having a sketch pad and some tools.

FIG. 9 is a top view of a computer mouse on an alternative mouse pad that has dedicated mouse pad area as well as a sketch pad and tools.

### DESCRIPTION OF THE PREFERRED EMBODIMENT

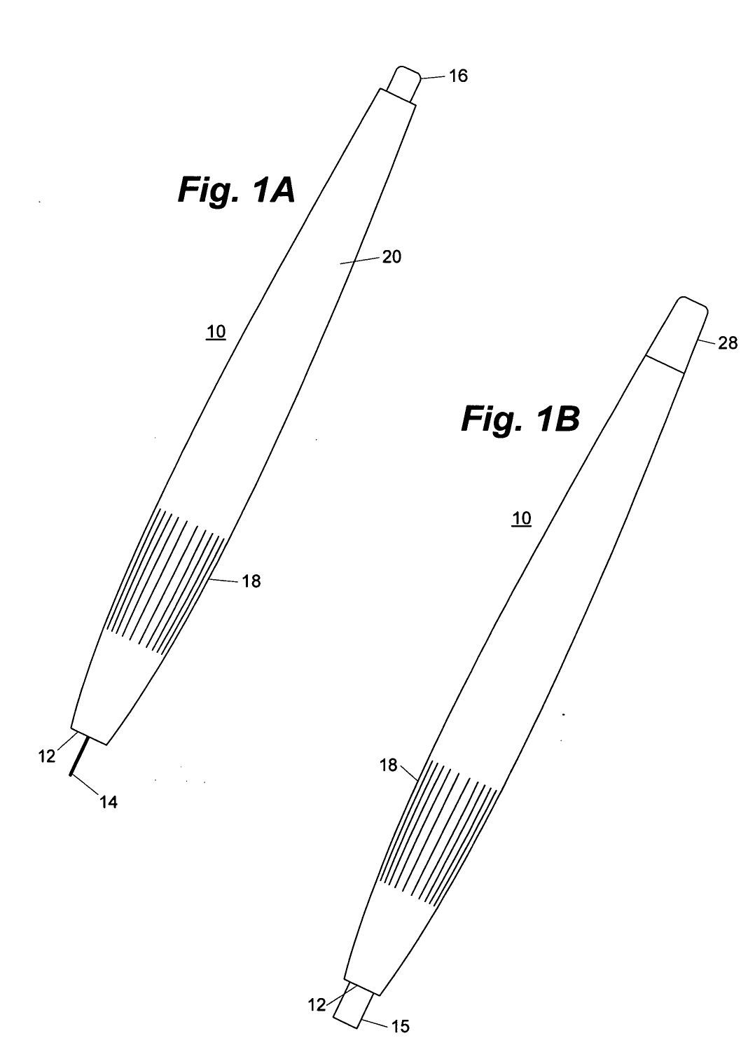

FIG. 1A show a special stylus 10 made according to the teachings of the current invention. It could also be called a pen, but since it does not normally carry real ink the term stylus is more accurate.

The stylus 10 includes an optical sensor 12, such as a miniature area scan camera. This optical sensor 12 may be identical or similar to those found in the prior art. This optical sensor 12 can see a specially prepared surface so that the exact location of the digital writing tip 14 on the surface can be determined. The specially prepared surface includes various tool pads and a sketch pad that is permanent and reusable.

Preferably, the stylus 10 has a digital writing tip 14. The digital writing tip 14 is just a pressure sensitive tip for sensing when the stylus 10 is in contact with the one of the pads. Real ink is not one of the features of the invention. Optionally, the stylus 10 also has a digital eraser tip 16 opposite the digital writing tip 14. The digital eraser tip 16 also has an optical sensor and a pressure sensitive tip.

The digital writing tip 14 may merely detect contact but preferably it also provides a measure of the force of contact. Although highly preferred, the ability to detect contact and measure the force are not absolutely necessary to the invention because contact can also be inferred optically.

Another optional feature of the invention is that it has a pressure sensitive ring 18 approximately where a user's fingers would hold the stylus when writing. This pressure sensitive ring is somewhat like a mouse button on a prior art stylus (for use with a tablet) but it is symmetrical around the stylus. That way, a user can activate it simply by squeezing without having to rotate the stylus to find a button.

The stylus 10 contains inside 20 a battery and wireless transmitter so that it can transmit location information and pressure sensitive tip information to a personal computer. The preferred method of transmission is Bluetooth. The receiver may be built into the computer or may be plugged into one of the computer's input ports, such as PCMCIA, USB, parallel or serial port, etc.

Alternatively, the stylus 10 and personal computer may use any other form of wired or wireless communication, including electromagnetic or optical. For example, since the stylus will usually be near the base of a notebook computer, it can transmit infrared signals to an infrared detector located just above the notebook computer's display screen. The infrared light should be emitted from several places and in all directions so that the users hand does not block all the IR light during normal use, including when erasing.

FIG. 1B shows an alternative stylus 10 with a cylindrical digital writing tip 15. It permits the optical sensor 12 to see though the void in the cylinder. As shown, it is a separate piece from the stylus 10 body, but it could also just be an extension of the stylus 10 body. Preferably, cylindrical digital writing tip 15 is clear to permit more light to get to the subject matter. The optical sensor 12 may have a visible or infrared light source nearby to shine light down the length of the cylinder.

The cylindrical digital writing tip 15 does not provide a sharp tip as users expect in writing instruments. However, the users eyes are supposed to be on the computer display during use, because that is where the position of the stylus 10 is revealed in the form of a cursor. Thus, the user does not need a sharp tip. Internally, the invention operates by making the centerline down the cylinder the “hot spot” for purposes of determining where the stylus is pointing.

Both types of digital writing tips (14,15) maintain a minimum distance between the optical sensor 12 and the subject matter in contact or near the digital writing tips (14,15).

FIG. 1B also shows a diffuser 28 that spreads out the infrared light from and internal infrared light source. This diffuser 28 makes sure the infrared light is transmitted to an infrared receiver on the computer regardless of the orientation (rotation) of the stylus.

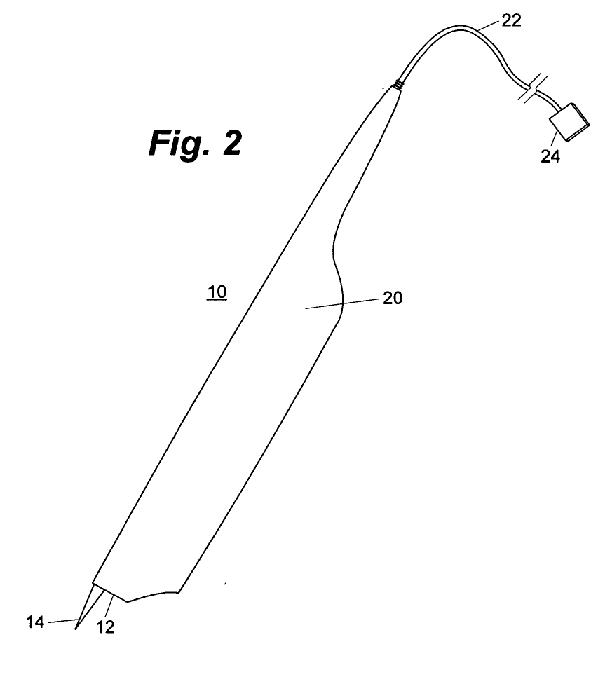

FIG. 2 shows an alternative stylus with a cable 22 leading to a USB connector 24 instead of a dedicated digital eraser tip 16. (The full length of the cable 22 is not shown.) This type of stylus 10 can still erase after picking up an eraser tool as is commonly done in drawing and painting software.

The alternative stylus of FIG. 2 also is not symmetrical about it longitudinal axis. It has an optical sensor on only one side of its digital writing tip 14. It is intended to be held a certain way and not rotated.

The connection methods shown (radio, infrared, cable) and tip variations shown (regular, cylindrical, asymmetric) are independent of each other. For example, there can be a stylus with a cylindrical digital writing tip and a cable.

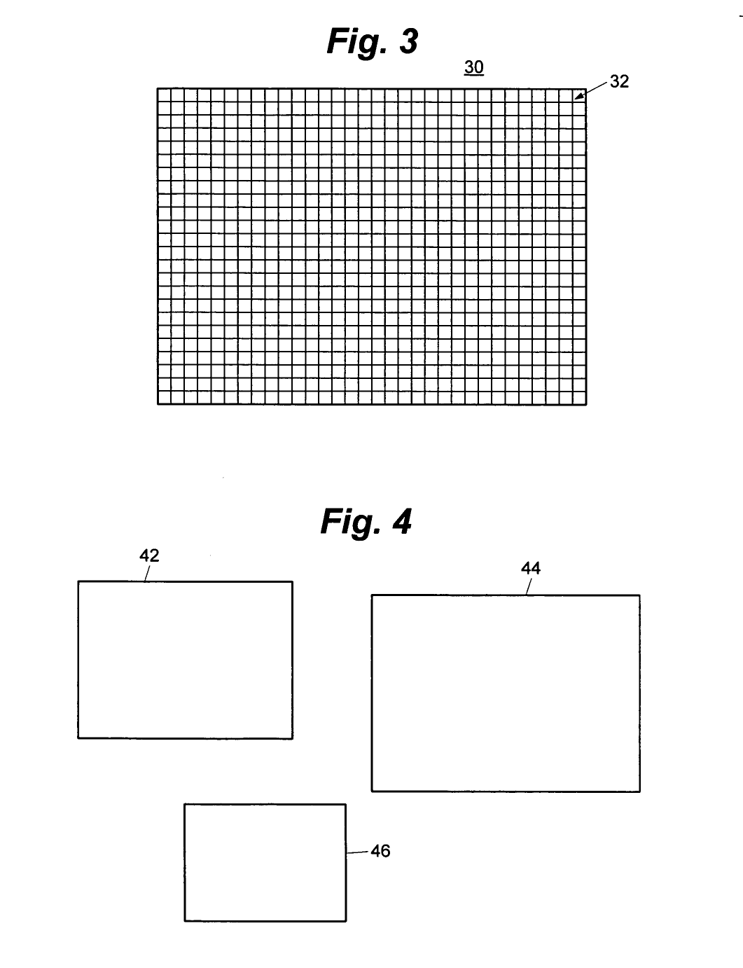

FIG. 3 shows a sketch pad 30. It is marked with location-revealing indicia 32 that cooperates with the stylus 10 to reveal where the tips (14, 16) are located. Such specially prepared surfaces are already common in the art. For the purposes of the current invention, the markings do not need to be light as in smart paper because no ink needs to be visible on them. The markings may be invisible, visible or even very obvious to the human eye, it does not matter.

According to the current invention, various types of sketch pads 30 can be provided. One preferred way is as an adhesive sticker that can be mounted on a the base of a notebook computer, either to the right or left of a touch pad. The mounting can be permanent or temporary as desired depending on the type of adhesive used. Other means of attachment may also be used, including cohesion, static electric, magnetic, friction, screws, bolts, etc. Alternatively, an original equipment manufacturer (OEM) may want to print a sketch pad directly on notebook computer or other computing device. The sketch pad may also be applied to a hard piece of material that may be placed on a computer or desk or keyboard drawer next to a mouse pad.

FIG. 4 shows the preferred way of providing the sketch pad 30, which is as a selection of adhesive-backed sketch pads (42, 44, 46) of various sizes. Thus, a person with a notebook computer can pick the best size pad for the amount of space available. The user may also want to apply a sketch pad near the mouse pad of a desktop computer.

The invention also provides for the selection of drawing tools using the stylus. This could be done by providing soft buttons displayed on the screen and selectable by stylus or other pointing device. However, the preferred way of providing drawing tools is to provide printed buttons that are recognizable by the stylus's optical sensor 12. These buttons are also printed on adhesive stickers. They could be put on the same sticker as the sketch pad, but it is preferred that they be provided as separate stickers grouped by function.

Providing drawing tools on separate stickers grouped by function has several advantages. It allows the user to choose the tools that will be important to them and only apply those to their notebook computer. It also allows the user to arrange the stickers on the notebook in a manner that makes sense to them and that fits in the space available.

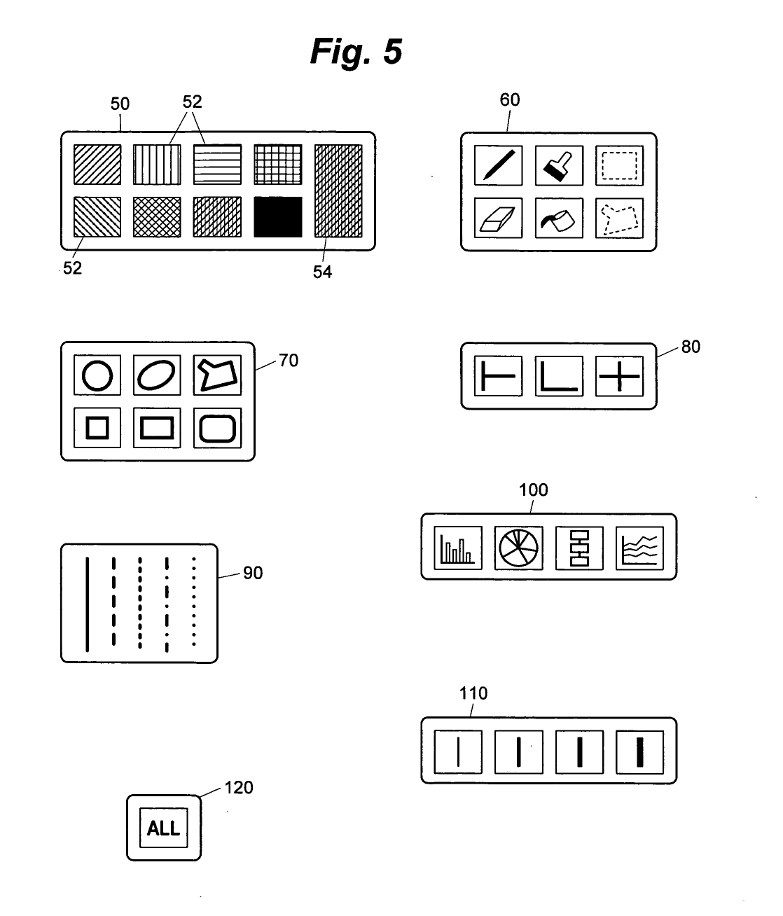

FIG. 5 shows the preferred way of providing various tools stickers. Each tools sticker contains one or more buttons that are recognizable by the stylus 10 as well as a human user. These buttons are ink printed on the sticker. The buttons have no functional parts other than the color or icon that reminds the user of their meaning and some manner of recognition for the stylus 10.

When the stylus is touched on one of the tools, its cursor on the computer display is changed (when possible) to represent the new tool. If the cursor is limited to black and white then color can not be changed. The display should also have a static display area that contains the current tool and color information, so that the user can see which tool and color are active regardless of where the cursor is.

The manner of recognition of these tools or buttons may be identical or keyed. Identical means that the stylus 10 or computer recognize the same colors and icon that the human sees. Keyed means that there are other symbols embedded among the colors or icons and that the stylus 10 recognizes these other symbols, which are keyed to the button's meaning. The stylus can report the button pressed, or which sticker and a location on the sticker, or the stickers can just present an extension of the same coordinate system of the sketch pad 166 which coordinate system is used regardless of the user's arrangement of the stickers. The keying can be done with infrared ink and light, with visible ink and light that does not interfere with the colors and icons.

The choice of tools and stickers to provide, their sizes and arrangements and choice of icons are all a matters of design. Indeed, several designs can be provided so that the user makes the final choice.

One such design is shown in detail in FIG. 5. The first sticker 50 contains eight color buttons 52 presenting eight different colors. When the user wants to draw with a different color of digital ink, he just touches the stylus 10 to one of the color buttons 52 to “pick up” the new color.

This first sticker 50 also includes a color picker button 54. It calls up a color picker soft tool to the display, where the user can pick a color that is not available among the eight color buttons 52.

The second sticker 60 contains some common drawing tools, including (from left to right, top row to bottom row): a pen, a paintbrush, a rectangular selection tool, an eraser, an area flood fill tool, and an irregular shape selection tool.

The third sticker 70 contains some common shape buttons including a circle, an ellipse, an irregular shape, a square, a rectangle, and a rounded rectangle.

The fourth sticker 80 contains buttons that allow placement of various X-Y coordinate grid shapes on a drawing, such as would be useful in a math class. These include a grid with no negative X axis, one with only the positive X and Y axes, and one with both positive and negative X and Y axes.

The fifth sticker 90 shows different line types that would be used when the pen or common shape tools are active. These “buttons” don't have defined boundaries, the lines plus a little surrounding space defining an area that needs to be touched with the stylus 10 to select the line. The lines include a solid line, a heavy dashed line and other lines all the way to a finely dotted line. This fifth sticker 90 also shows that the icons do not really have to be in boxes.

The sixth sticker 100 contains charts and graphs of various kinds, such as would be useful to a business major. It shows a histogram, a pie chart, a flowchart or organizational diagram, and comparison graph. When one of these is selected, a smart shape is inserted into the users drawing. The user is then free to customize the number of bars or sections, their sizes and colors, etc.

The seventh sticker 110 shows different line weights from thin to very heavy.

The eighth sticker 120 has only one button which has a special function. It calls up all the available buttons to the display as soft buttons. Thus, the user may only apply stickers for the most important buttons to the notebook computer and yet still have all the functionality of all the buttons available. Preferably, the functionality of the eighth sticker's button is duplicated in software with a keystroke combination and menu item as well.

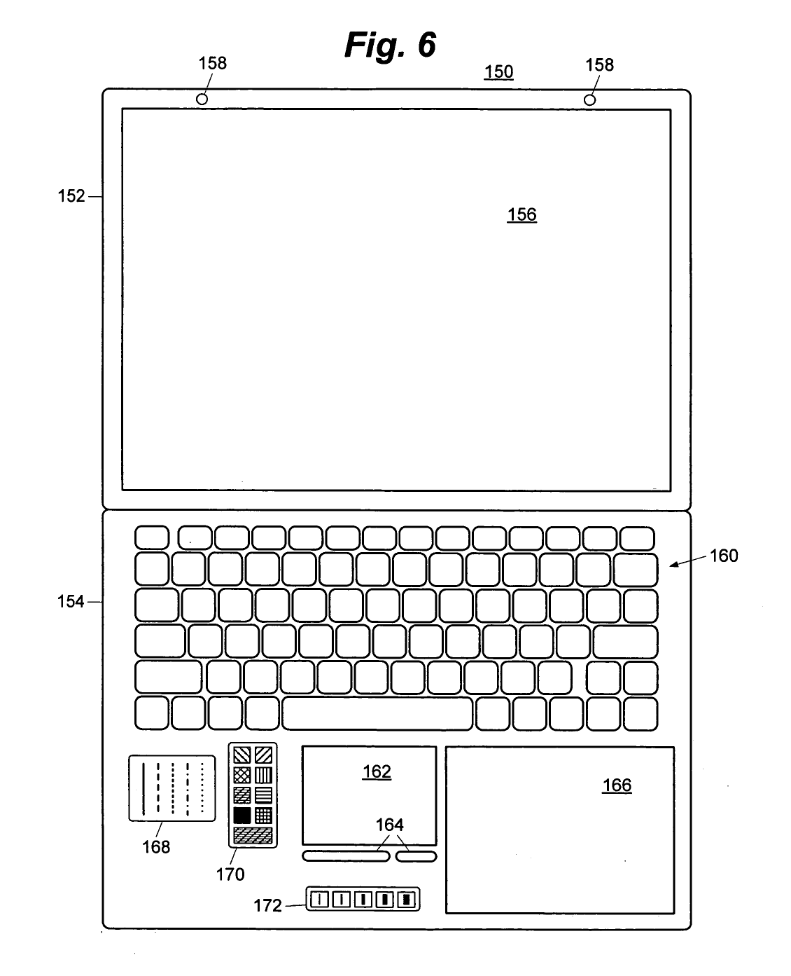

FIG. 6 shows a notebook computer 150 modified according to the current invention. It has a display member 152 and a base member 154. The display member has a display 156. It may optionally have one or more infrared receiving devices 158 as well, if infrared transmission is being used to communicate signals from the stylus 10 to the notebook computer. The base member 154 has a keyboard 160, touch pad 162 and mouse buttons 164.

According to the invention, the user applied stickers to the base member 154 of the notebook computer 150. These include a sketch pad sticker 166 and the user's choice of various tools stickers (168, 170, 172). An appropriately sized sketch pad sticker 166 may be applied to the right or left based on the user's preferred writing and drawing hand.

The advantage of providing the sketch pad 166 and tools (168, 170, 172) as adhesive stickers is that the end user may select and place these stickers in a custom arrangement as space and individual needs dictate. Another advantage is that they may be added to existing computers of all types. It is of particular advantage to notebook computers because stickers take up so little space that the notebook can still be closed normally with the sketch pad 166 inside. That can not be done with a traditional graphic tablet and stylus.

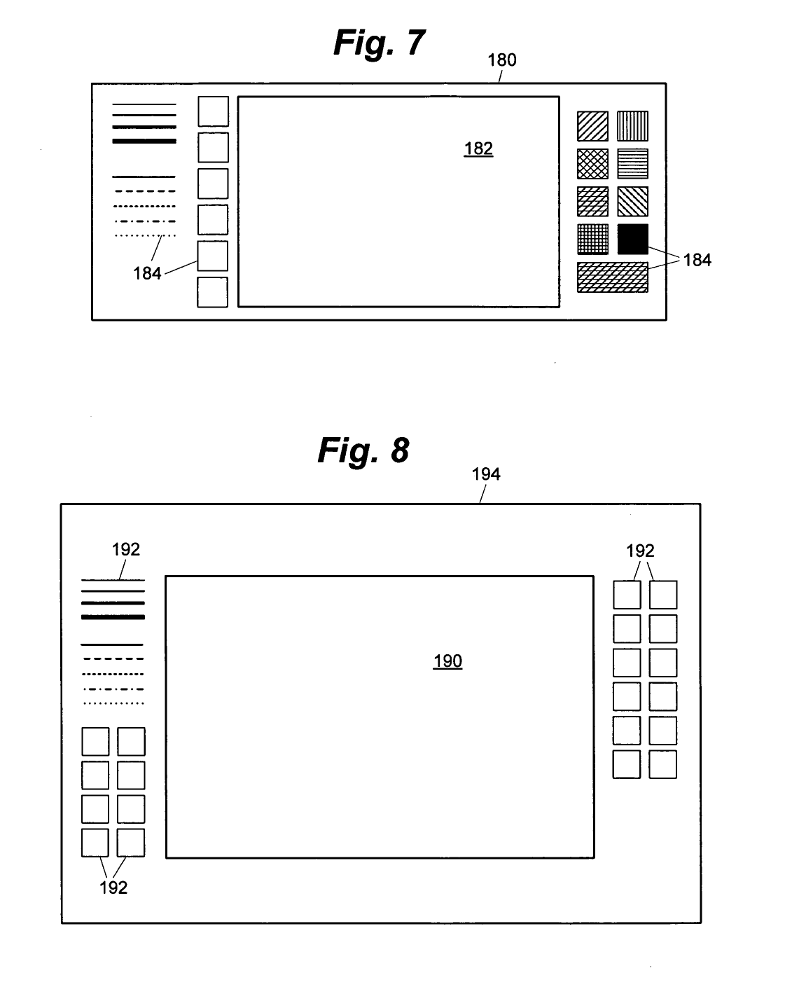

FIG. 7 shows another way of providing the sketch pad and tools of the invention. Here, the sketch pad 182 and the most popular tools 184 are printed on the surface of a base member 180 that is somewhat similar to a mouse pad. This base member 180 is intended to be placed on a desk or keyboard drawer. It may be flexible or rigid. Preferably, it has a non-slip backing material or non-slip feet. This way of providing the invention has the advantage of taking up little space on a desk or keyboard drawer, such as near an existing mouse pad.

FIG. 8 shows a variation of FIG. 7 in which the sketch pad 190 and tools 192 are printed on a mouse pad 194 so that they share the same space. This has the advantage of requiring no more desk or keyboard drawer space than an existing mouse pad requires. It also has the advantage of being relatively easy to manufacture because many companies already produce mouse pads of that form factor with various pictures on their surfaces.

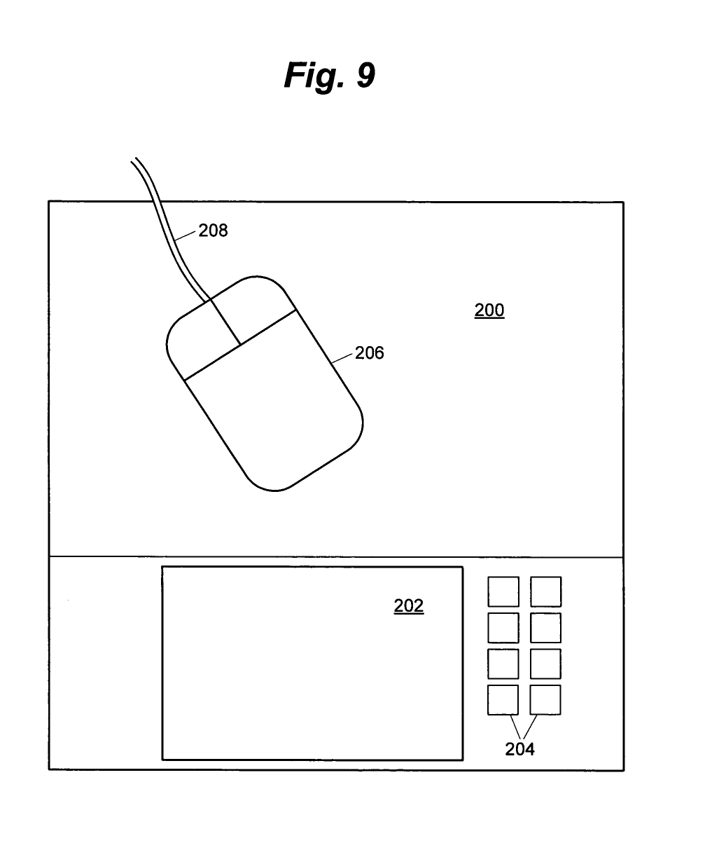

FIG. 9 shows a variation of FIG. 7 with an integrated dedicated mouse pad area 200. Any arrangement is usable, but it is preferred that the integrated dedicated mouse pad area 200 be behind the sketch pad 202 and tools 204 so that the mouse 206 or mouse cord 208 (if any) do not tend to be in the way of the sketch pad, tools or the users hand or wrist. This integrated dedicated mouse pad variation is for use on a desktop or keyboard drawer where there is room for a deeper mouse pad.

Yet another way of providing the invention is for manufacturers or value added resellers of computers, computer peripherals, computer furniture or keyboard trays to mount the sketch pad 166 and tools (168, 170, 172) on surfaces of the various products they produce. The sketch pad and tools may be printed directly on these surfaces, but it will likely be preferable to print them on plates or sheets and permanently mount these plates or sheets on the goods.

Internal Operation

The sketch pads are made of indicia affixed to any suitable surface. The indicia are markings that encode their two-dimensional location. In other words, the markings on the sketch pad portion of the surface vary in accordance with the location of the marking. These variations reveal where each marking is located on the sketch pad portion of the surface. Thus, by examining just a small portion of the markings, it is possible for a computing device to determine the complete location information of the markings being examined. The field of view of the optical stylus should be large enough to always encompass at least one such small portion wherever the stylus is applied to the sketch pad.

The prior art teaching several such patterns of markings that can be used with the current invention. It should be noted that since the current invention does not use a pen that delivers ink, there is no requirement for the current invention that the markings be light enough to allow user-applied indicia to be seen. In other words, the sketch pad may appear to a human observer to have an overall dark or light shade or anything in-between. This provides additional flexibility to the current invention.

Preferably, the encoding should be unambiguous even when rotated. This is more important for optical styluses that may be freely rotated about their longitudinal axis than for those that have to be held a certain way. A system of markings that are unambiguous even when rotated is an advantage for simplicity and reliability, but it is not a requirement. For example, seeing multiple adjacent markings can resolve questions of rotation by trial and error; when all adjacent markings make sense, then the rotation question is resolved.

The sketch pad portion may be all or part of the surface. Usually, it is a rectangle that has the same aspect ratio of the computer screen with which it is intended to be used.

The stylus includes an area scan camera that is responsible for optically detecting (seeing) the encodings of two-dimensional location. The camera should be fixed focus and have adequate depth of field to clearly see the encodings under normal use. Normal use includes the various angles that users will hold the stylus to the sketch pad. Normal use also includes a hover distance over the surface.

By detecting and transmitting data even when the stylus is hovering over the sketch pad, it is possible for the computer to display a cursor on the computer's display before the user touches the stylus to the sketch pad. This gives the user valuable feedback and allows the user to move the stylus to the exact point desired before starting to draw.

To conserve battery life, it is preferable that the stylus transmit data only when it is hovering over the sketch pad within a predetermined hover distance, or when the stylus is in contact with the sketch pad or one of the tools. It is not necessary to transmit data when the stylus is out of range of the sketch pad or when it is hovering over a tool pad. (Note that soft tools on the display screen are accessed via the sketch pad and thus hovering is tracked.)

The stylus transmits when something is contacting it at the tip. It also transmits when a focused image is in view, particularly if it can tell that the image is a portion of the sketch pad.

The stylus preferably powers itself down when it is not in use. This can be accomplished in any one or more of several ways: By providing a power switch; by providing a timer that powers it down after a predetermined time of non-use, with use determined by pressing the stylus against a surface; by providing an orientation detection device so that the stylus powers down immediately whenever it is laying on its side; or by providing it with a magnetic switch so that it powers down immediately upon being placed in a magnetic stylus holder that bears a permanent magnet.

According to the invention, at some point the encodings of two-dimensional locations that are seen by the area scan camera have to be recognized and converted to location data. This could be done in the stylus, in a receiving unit connected to or contained in the computer, or by the computer's CPU. It does not matter where this is done except for minor advantages and disadvantages inherent in each choice.

If done in the computer's CPU, the stylus sends the raw (unprocessed) video frames from the area scan camera to the computer for processing. This means the data rate between the pen and the computer will be somewhat high, but it keeps the stylus simple and thin. The transmitter should save power by transmitting video frames in bursts that are as short as possible. This can be done in a wired or wireless manner. This method is preferred where economy is the highest priority.

If done in the stylus, the optical stylus must also include the computational electronics to interpret the markings that encode their two-dimensional location, and transmit the location data to the computer. This adds size, weight, complexity and cost to the stylus. It also likely reduces its battery life. The advantage is that it offloads this task from the computer and makes it possible for the stylus to appear to be a mouse if desired. This also can be done in a wired or wireless manner.

If done in a receiving unit, then it is necessary to provide a receiving unit that plugs into the computer somewhere, such as a USB port or PCMCIA slot. It may also be built into the computer by an OEM. This receiving unit receives raw video from the stylus. It interprets the markings that encode their two-dimensional location and converts them to location data. This third way also can be done in a wired or wireless manner. It has the advantages of keeping the stylus light, simple and thin and also offloading the image processing from the computer. This method is most preferred for high-end applications.

All of these ways of transmitting data from the stylus to the computer do so in real time. The current invention does not require that the stylus store data for later downloading. The lack of storage circuitry is an additional advantage that simplifies the stylus of the current invention as compared to some digital pens in the prior art.

The stylus may be provided with hardware or software driver that causes it to be viewed (by the computer) as an ordinary mouse or other pointing device. However, it is preferred that it can send absolute coordinate positions to applications, which facilitates the natural drawing of sketches in several ways: (1) With absolute coordinates, a horizontal line on the sketch pad is converted into a horizontal line on screen, regardless of the orientation of the stylus. (2) With absolute coordinates, there can be no “pointer acceleration” or “precision enhancement” which help mice work but distort sketches.

It may also be provided with software driver that makes it look like an ordinary stylus and tablet to the computer and user. In other words, when the stylus is brought into range of the sketch pad, the mouse cursor immediately jumps to the absolute position seen by the stylus. When the stylus is put down or is taken out of hovering range, the cursor stays in position. Mouse movements start from the cursor's new location. Thus, the stylus and mouse or track pad share the same cursor.

An optional additional feature of the preferred embodiment of the invention is that the invention be provided with a sketch device driver. This is software driver that interprets the location data and converts it to custom messages to be passed through the operating system directly to a compatible application program. These custom messages are like ordinary mouse movement and mouse click messages but they differ in that they are distinguishable from mouse movement. Thus, the use of the stylus of the current invention does not cause the computer's mouse cursor to be affected. Instead, use of the stylus causes a separate drawing cursor to appear. This separate drawing cursor has its own icon that depends on the tool that is active and never looks like the mouse cursor. The compatible application also has the options of defining unique behaviors that differ from the behavior of the mouse cursor, such as drawing on text rather than selecting text. The special drawing cursor disappears when the stylus is put down or taken out of range of the sketch pad and tools.

After installation of the stylus on the computer, if there is a choice of many different sketch pads, the installation program may need to configure the computer to work with the particular sketch pad that was chosen by the user. For example, it may ask the user to point the stylus to the upper left and lower right corners so as to determine the orientation of the pad and its maximum extents.

If the different sketch pads use different types of markings and the user is instructed to orient them a certain way then this setup step is unnecessary. For example, it may be advantageous to provide different types of markings optimized for different display resolutions such as SVGA, XGA, UXGA. Each of these can be provided in a variety of physical sizes, with markings scaled accordingly. If the user changes resolutions, then the sketch pad can be remapped in software to the new screen resolution. Thus various sketch pad stickers and tool stickers can be provided with an optital stylus as a kit for retrofitting existing notebook computers that were manufacured without a sketchpad and stylus.

While the current invention has been illustrated by description of several embodiments thereof, the scope of the invention is to be determined by the appended claims.

I claim:

1. A computer sketch pad and stylus kit for use with an existing notebook computer, comprising:
a. at least one sketch pad, each said sketch pad having a top and bottom surface;
b. indicia on the top surface of said sketch pad, said indicia encoding its two-dimensional location over its surface;
c. an adhesive on the bottom surface of said sketch pad for attaching said sketch pad to said existing notebook computer;
d. an optical stylus having means for optically detecting the encodings of two-dimensional location and said optical stylus also having means for transmitting data derived from its optical detections to said existing notebook computer.

2. The computer sketch pad and stylus of claim 1 wherein said optical stylus includes processor means for interpreting said encodings of two-dimensional location to derive location data and wherein said means for transmitting data to said existing notebook computer comprises means for transmitting location data to said existing notebook computer.

3. The computer sketch pad and stylus of claim 1 additionally comprising software driver means for said existing notebook computer, wherein said means for transmitting data to said existing notebook computer comprises means for transmitting said encodings of two-dimensional location as raw video frames to said computer and wherein said software driver means includes means for interpreting said encodings of two-dimensional location as raw video frames to derive location data.

4. The computer sketch pad and stylus of claim 1 wherein said optical stylus additionally comprises contact detection means on its lower end and wherein said means for transmitting data to the computer includes means for transmitting the contact and no contact status of said contact detection means.

5. The computer sketch pad and stylus of claim 1 wherein said optical stylus additionally comprises force detection means on its lower end and wherein said means for transmitting data to the computer includes means for transmitting the force detected by said force detection means.

6. The computer sketch pad and stylus of claim 1 additionally comprising means for optically determining the hovering distance of said optical stylus in a third dimension.

7. The computer sketch pad and stylus of claim 1 additionally comprising tool button indicia near said sketch pad, and wherein said optical stylus additionally transmits tool button data to said existing notebook computer.

8. A computer mouse pad and stylus for use with an existing computer, comprising:
a. sketch pad indicia on the top surface of said mouse pad, said indicia encoding its two-dimensional location over at least a portion of said top surface;
b. a plurality of tool button indicia on the top surface of said mouse pad outside said sketch pad indicia, each said tool button indicia being visibly unique and recognizable to a person;
c. an optical stylus having means for optically recognizing the encodings of two-dimensional location, optically recognizing each of said plurality of tool button indicia, and said optical stylus also having means for transmitting data derived from its optical recognition to said existing notebook computer.

9. A portable notebook computer with tablet and stylus system, said system comprising a notebook computer that comprises a display member and a base member, said display member comprising a display and said base member comprising a keyboard and a sketch pad, said sketch pad bearing location-revealing indicia encoding two dimensional location codes at a plurality of points covering the surface of said sketch pad, said system additionally comprising an optical stylus cooperating with said sketch pad by transmitting location data to said notebook computer.

10. The portable notebook computer with tablet and stylus system of claim 8 additionally comprising tool button indicia on said base member and wherein said optical stylus additionally transmits tool button data to said notebook computer.
